(19) United States
(12) Patent Application Publication
(10) Pub. No.: US 2026/0246363 A1
(43) Pub. Date: Aug. 20, 2026

(54) POWER SUPPLY APPARATUS AND CONVERTER CONTROL METHOD

(71) Applicant: Magnachip Semiconductor, Ltd., Cheongju-si (KR)

(72) Inventors: Seokjin HAM, Seoul (KR); Sanghyung LEE, Seoul (KR); Gyuho LIM, Cheongju-si (KR)

(73) Assignee: Magnachip Semiconductor, Ltd., Cheongju-si (KR)

(21) Appl. No.: 19/411,613

(22) Filed: Dec. 8, 2025

(30) Foreign Application Priority Data
Feb. 17, 2025 (KR) 10-2025-0020275
Oct. 15, 2025 (KR) 10-2025-0148391

(51) Int. Cl. H02M 1/00; G09G 3/3225; H02M 3/158

(52) U.S. Cl. CPC H02M 1/009; G09G 3/3225; H02M 1/0025; H02M 3/158; G09G 2330/028

(57) ABSTRACT

A power supply apparatus includes a power supply unit with a single inductor bipolar output (SIBO) converter structure that uses a single inductor to receive an input voltage through multiple switches and generate a first output voltage and a second output voltage. One end of the inductor is connected to an input voltage terminal, and a diode is coupled to the same end of the inductor. A power supply control unit controls operation of the switches to regulate the output voltages.

### CROSS REFERENCE TO RELATED APPLICATION

The present application claims priority to Korea Patent Application No. 10-2025-0020275, filed on February 17, 2025, and Korea Patent Application No. 10-2025-0148391, filed on October 15, 2025, the entire contents of which are incorporated herein by reference in their entirety.

### BACKGROUND

### Field

Various embodiments of the present disclosure relate to a power supply apparatus and a method for controlling a converter.

### Discussion of Related Art

The statements in this section merely provide background information related to the present disclosure and do not necessarily constitute prior art.

Recently, active-matrix organic light-emitting diode (AMOLED) displays have been widely adopted in electronic devices such as mobile phones, tablet PCs, laptops, and wearable products due to their advantages, including high resolution, reduced power consumption, and a thin form factor.

An organic light-emitting diode (OLED) panel operates only when a first output voltage (VOP), which is positive, and a second output voltage (VON), which is negative, are simultaneously supplied. The brightness and image quality depend on the magnitude of the current delivered to each pixel. The driving voltages may vary depending on factors such as panel size, resolution, pixel counts, and the configuration of drive IC, and different voltage levels may be required based on the application environment.

A voltage supplied from a battery is generally in the range of about 2.9V to 4.5V; however, recent designs require a battery environment capable of supporting up to 5V. In conventional AMOLED driving schemes, fixed positive and negative voltages, such as +4.6V and -2.4V, are typically generated. Recently, there has been a demand to vary the positive voltage from 4.6V to 3.3V depending on the operating conditions of the drive IC.

However, in conventional boost-converter-based power supply architectures, it is difficult to stably generate a first output voltage (VOP) that is lower than the input voltage (VIN). For example, when the input voltage VIN reaches 4.5 V or higher due to battery overcharging, it becomes impossible – or at least significantly more complex – to regulate VOP down to 3.3 V. Consequently, the driving range of the AMOLED panel becomes restricted, making it difficult to meet the required operating conditions of the driver IC.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a power supply apparatus includes: a power supply unit having a single inductor bipolar output (SIBO) converter structure including a single inductor, the power supply unit being configured to receive an input voltage from an input voltage terminal through a plurality of switches connected to the inductor and to generate a first output voltage and a second output voltage, and having one end of the inductor connected to the input voltage terminal and including a diode connected to the one end of the inductor; and a power supply control unit configured to control an operation of the plurality of switches.

The plurality of switches may include: a first switch connected to the one end of the inductor; a second switch connected to another end of the inductor; a third switch connected between the another end of the inductor and a first output voltage terminal; and a fourth switch connected between the one end of the inductor and a second output voltage terminal.

A source terminal of the first switch may be connected to the input voltage terminal and a drain terminal of the first switch may be connected to the diode and the one end of the inductor.

A drain terminal of the second switch may be connected to the another end of the inductor and a source terminal of the second switch may be connected to a ground terminal.

A drain terminal of the third switch may be connected to the another end of the inductor and a source terminal of the third switch may be connected to the first output voltage terminal, and a drain terminal of the fourth switch may be connected to the one end of the inductor and a source terminal of the fourth switch may be connected to the second output voltage terminal.

A cathode electrode of the diode may be connected to a first node to which the first switch, the fourth switch and the one end of the inductor are connected in common, and an anode electrode of the diode may be connected to a ground terminal.

The power supply unit may further include a resistor connected between the diode and the first node.

The power supply unit may further include an input capacitor having a first electrode connected between a source terminal of the first switch and ground.

The power supply unit may include: a first output capacitor connected between the first output voltage terminal and the third switch; and a second output capacitor including a first electrode connected between the second output voltage terminal and the fourth switch.

The power supply unit may include: a first error amplifier configured to compare a first feedback voltage provided from the first output voltage terminal and a reference voltage and output a first error amplification voltage; a second error amplifier configured to compare a second feedback voltage provided from the second output voltage terminal and a ground voltage and output a second error amplification voltage; a voltage adder configured to add up the first error amplification voltage and the second error amplification voltage and output a summation voltage; a ramp generator configured to generate a ramp signal; a first pulse modulator configured to compare a superposition signal obtained by adding up an output voltage of the inductor and the ramp signal and the summation voltage and generate a first PWM signal; a second pulse modulator configured to compare the second error amplification voltage and the superposition signal and generate a second PWM signal; and a control unit configured to control the plurality of switches based on the first PWM signal and the second PWM signal.

The first feedback voltage may be a voltage transferred from the first output voltage terminal through a resistive divider circuit, and the second feedback voltage may be a voltage transferred from the second output voltage terminal through a resistive divider circuit.

An output voltage of the inductor may be a voltage of a second node to which the another end of the inductor, the second switch and the third switch are connected in common.

The control unit may receive the first PWM signal and the second PWM signal and output first to fourth control signals for controlling the first to fourth switches, respectively.

In another general aspect, a method for controlling a single inductor bipolar output (SIBO) converter including a single inductor, the method including: providing the SIBO converter that may further include: a first switch connected to one end of the inductor; a second switch connected between another end of the inductor and a ground; a third switch connected between the another end of the inductor and a first output voltage terminal; and a fourth switch connected between the one end of the inductor and a second output voltage terminal; charging energy in the inductor by controlling the first switch and the second switch to be in an on state and controlling the third switch and the fourth switch to be in an off state; and outputting the first output voltage by controlling the second switch and the fourth switch to be in an off state, maintaining the third switch in an on state, and controlling the first switch to be turned on or off.

The charging of the energy in the inductor may further include: outputting a second output voltage by controlling the first switch and the third switch to be in an off state and controlling the second switch and the fourth switch to be in an on state.

The method may further include: generating a first feedback voltage from the first output voltage terminal through a resistive divider circuit; and generating a second feedback voltage from the second output voltage terminal through a resistive divider circuit.

The method may further include: outputting a first error amplification voltage by comparing the first feedback voltage and a reference voltage; outputting a second error amplification voltage by comparing the second feedback voltage and a ground voltage; and outputting a summation voltage by adding up the first error amplification voltage and the second error amplification voltage.

The method may further include: generating a ramp signal having a periodical waveform; and generating a superposition signal by adding up an output voltage of the inductor and the ramp signal.

The method may further include: generating a first PWM signal by comparing the summation voltage and the superposition signal; and generating a second PWM signal by comparing the second error amplification voltage and the superposition signal.

The method may further include: receiving the first PWM signal and the second PWM signal; and outputting first to fourth control signals for controlling the first to fourth switches according to the first PWM signal and the second PWM signal.

According to embodiments of the present disclosure, adopting a single inductor bipolar output (SIBO) converter structure enables the power supply apparatus to operate stably even when the input voltage VIN exceeds the first output voltage VOP. For example, when the battery voltage is elevated to 4.5V or higher, the first output voltage VOP can still be reliably regulated to approximately 3.3V, thereby widening the available driving range of an AMOLED display.

In addition, because the first output voltage VOP and the second output voltage VON can be adjusted across a wide range, the power supply apparatus can support various voltage levels depending on factors such as display panel size, resolution, and the requirements of the display driver IC. As a result, the applicability of the apparatus can extend from compact mobile devices to large-format displays.

Further, incorporating an asynchronous rectifying diode within the power supply unit simplifies switch control and reduces the complexity of the control circuit. This configuration facilitates greater integration and compactness of the power supply apparatus and may reduce overall system implementation costs.

Moreover, by effectively managing ripple of the inductor current (IL), power efficiency can be increased and heat generation reduced during display operation. Consequently, drive-power consumption may decrease, and the stability and reliability of AMOLED display image quality may be improved.

The effects described above are illustrative and not exhaustive. Additional technical advantages and effects will be apparent to those of ordinary skill in the art from the following description, the drawings, and the claims.

### BRIEF DESCRIPTION OF THE DRAWINGS

FIG. 1 illustrates a display device according to an embodiment of the present disclosure.

FIG. 2 illustrates a power supply apparatus according to an embodiment of the present disclosure.

FIG. 3 illustrates an example of controlling a plurality of switches so as to store energy in an inductor of a power supply unit according to an embodiment of the present disclosure.

FIG. 4 illustrates an example of controlling a plurality of switches so as to activate a first output voltage according to an embodiment of the present disclosure.

FIG. 5 illustrates an example of further including a resistance connected in series to a diode illustrated in FIG. 4.

FIG. 6 illustrates an example of controlling a plurality of switches so as to activate a second output voltage according to an embodiment of the present disclosure.

FIG. 7 illustrates an operation of a plurality of switches which activates a first output voltage and a second output voltage according to an embodiment of the present disclosure.

FIG. 8 illustrates an operation of a plurality of switches which adjusts a first output voltage according to an embodiment of the present disclosure.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

Advantages and features of the present disclosure, and implementation methods thereof will be clarified through following aspects described with reference to the accompanying drawings. The present disclosure may, however, be embodied in different forms and should not be construed as limited to the aspects set forth herein. Rather, these aspects are provided so that this disclosure will be thorough and complete, and will fully convey the scope of the present disclosure to those skilled in the art. Furthermore, the present disclosure is only defined by scopes of claims. Like reference numerals refer to like elements throughout.

When an arbitrary component is described as “being connected to “or” being linked to” another component, this should be understood to mean that still another component(s) may exist between them, although the arbitrary component may be directly connected to, or linked to, the second component. In contrast, when an arbitrary component is described as “being directly connected to” or “being directly linked to” another component, this should be understood to mean that no component exists between them. “And/or” includes all of one or more combinations defined by related components.

The terms used in the present application are used to describe only specific embodiments or examples, and are not intended to limit the present disclosure. A singular expression can include a plural expression as long as it does not have an apparently different meaning in context. In a case where ‘comprise’, ‘have’, and ‘include’ described in the present specification are used, another part may be added unless ‘only’ is used. The terms of a singular form may include plural forms unless referred to the contrary.

Although the terms including an ordinal number such as first, second, etc. may be used for describing various elements, the structural elements are not restricted by the terms. The terms are only used to distinguish one element from another element.

The use of the term "may" herein with respect to an example or embodiment, e.g., as to what an example or embodiment may include or implement, means that at least one example or embodiment exists where such a feature is included or implemented, while all examples are not limited thereto.

Therefore, a first component to be mentioned below may be a second component in a technical concept of the present disclosure. Unless otherwise defined, all terms including technical and scientific terms used herein have the same meaning as commonly understood by one of ordinary skill in the art to which this disclosure belongs. It will be further understood that terms, such as those defined in commonly used dictionaries, will not be interpreted in an idealized or overly formal sense unless expressly so defined herein.

A term “part” or “module” used in the embodiments may mean software components or hardware components such as a field programmable gate array (FPGA), an application specific integrated circuit (ASIC). The “part” or “module” performs certain functions. However, the “part” or “module” is not meant to be limited to software or hardware. The “part” or “module” may be configured to be placed in an addressable storage medium or to restore one or more processors. Thus, for one example, the “part” or “module” may include components such as software components, object-oriented software components, class components, and task components, and may include processes, functions, attributes, procedures, subroutines, segments of a program code, drivers, firmware, microcode, circuits, data, databases, data structures, tables, arrays, and variables. Components and functions provided in the “part” or “module” may be combined with a smaller number of components and “parts” or “modules” or may be further divided into additional components and “parts” or “modules”.

Methods or algorithm steps described relative to some embodiments of the present disclosure may be directly implemented by hardware and software modules that are executed by a processor or may be directly implemented by a combination thereof. The software module may be resident on a RAM, a flash memory, a ROM, an EPROM, an EEPROM, a resistor, a hard disk, a removable disk, a CD-ROM, or any other type of record medium known to those skilled in the art. An exemplary record medium is coupled to a processor and the processor can read information from the record medium and can record the information in a storage medium. In another way, the record medium may be integrally formed with the processor. The processor and the storage medium may reside in an application specific integrated circuit (ASIC). The ASIC may be resident within a user’s terminal.

Hereinafter, a detailed description will be given as to the embodiments of the present disclosure with reference to the accompanying drawings in order for those skilled in the art to embody the present disclosure with ease. But the present disclosure is susceptible to variations and modifications and not limited to the embodiments described herein.

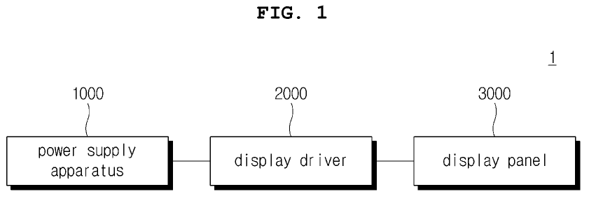

FIG. 1 illustrates a display device according to an embodiment of the present disclosure.

Referring to FIG. 1, the display device 1 according to an embodiment of the present disclosure may mean a device capable of displaying images or videos. For example, the display device 1 may be a smartphone, a tablet personal computer, a mobile phone, a computer, a camera and a wearable device, and the like, but is not limited thereto.

According to an embodiment, the display device 1 may include a power supply apparatus 1000 configured to supply power to a display driver 2000, the display driver 2000 for driving a display panel 3000, and the display panel 3000.

According to an embodiment, the power supply apparatus 1000 may generate a first output voltage VOP having a positive voltage and a second output voltage VON having a negative voltage and transfer them to the display driver 2000. The first output voltage VOP and the second output voltage VON provided by the power supply apparatus 1000 may vary according to a size of the display panel 3000, a resolution, the number of pixels, a structure of the display driver 2000 and the like, and various voltage levels may be required according to an application environment. The power supply apparatus 1000 may vary and provide the first output voltage VOP according to a drive condition of the display driver 2000. The configuration and the operation of the power supply apparatus 1000 in detail will be described with reference to drawings below.

According to an embodiment, the display driver 2000 may control the operation of the display panel 3000. The display driver 2000 may request and receive a voltage level needed according to a control condition of the display panel 3000. For example, the display driver 2000 may include a timing controller, a source driver, and a gate driver, and operate by receiving a voltage needed for an operation of each component from the power supply apparatus 1000.

According to an embodiment, the display panel 3000 may include a plurality of sub-pixels PX arranged in columns and rows for displaying a screen. For example, the display panel 3000 may be an active-matrix OLED (AMOLED) panel which drives an organic light emitting diode (OLED). The present disclosure is not limited thereto, and the display panel 3000 may be applied to various panel structures which need a driving voltage such as a liquid crystal display (LCD) panel and may be implemented as various display devices.

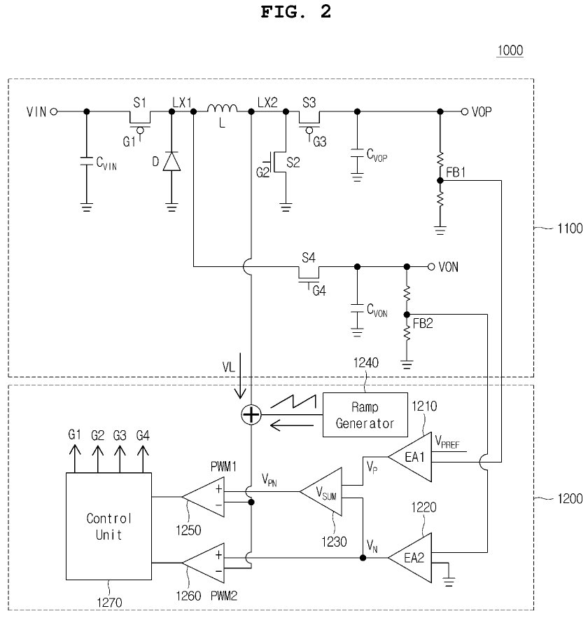

FIG. 2 illustrates the power supply apparatus according to an embodiment of the present disclosure.

Referring to FIG. 2, the power supply apparatus 1000 according to an embodiment of the present disclosure has a single inductor bipolar output (SIBO) converter structure including a single inductor L, and may include a power supply unit 1100 configured to generate a first output voltage VOP and a second output voltage VON from the input voltage VIN through a plurality of switches S1, S2, S3 and S4 connected to the inductor L, and including a diode D connected between the inductor L and a ground GND, and a power supply control unit 1200 configured to control the plurality of switches S1, S2, S3 and S4.

According to an embodiment, the power supply unit 1100 may include an input voltage terminal, an input capacitor CVIN, the inductor L, the diode D, the plurality of switches S1, S2, S3 and S4, a first output voltage terminal, a second output voltage terminal, a first output capacitor CVOP and a second output capacitor CVON.

According to an embodiment, the input voltage terminal may be connected to a power supply device (for example, a battery) and receive an input voltage. The input voltage terminal may be connected to the inductor L through the first switch S1.

According to an embodiment, the input capacitor CVIN may be connected between the input voltage terminal and the ground GND. The input capacitor CVIN may be connected in parallel to the first switch S1. For example, the input capacitor CVIN may store energy transferred from the input voltage terminal, and then, transfer the stored energy to the inductor stably.

According to an embodiment, the plurality of switches S1, S2, S3 and S4 may include the first switch S1 connected to one end of the inductor, the second switch S2 connected between another end of the inductor and the ground, the third switch S3 connected between the another end of the inductor and the first output voltage terminal, and the fourth switch S4 connected between the one end of the inductor and the second output voltage terminal. The first switch S1 may be connected between the input power terminal and the inductor L.

According to an embodiment, a source terminal of the first switch S1 may be connected to the input voltage terminal and a drain terminal thereof may be connected to the one end of the inductor. A drain terminal of the second switch S2 may be connected to the another end of the inductor and a source terminal thereof may be connected to the ground terminal. A drain terminal of the third switch S3 may be connected to the another end of the inductor and a source terminal thereof may be connected to the first output voltage terminal. A drain terminal of the fourth switch S4 may be connected to the one end of the inductor and a source terminal thereof may be connected to the second output voltage terminal.

According to an embodiment, each of the first to fourth switches S1, S2, S3 and S4 may receive first to fourth control signals G1, G2, G3 and G4 from a control unit 1270 of the power supply control unit 1200, and may operate in an on state or an off state. For example, each of the first to fourth switches S1, S2, S3 and S4 may be implemented as a MOSFET switch, and may be operated in an on state or an off state as the control signal is provided to the gate terminal from the control unit 1270.

According to an embodiment, the first switch S1 and the third switch S3 may be implemented as p-type MOSFETs, and the second switch S2 and the fourth switch S4 may be implemented as n-type MOSFETs.

According to an embodiment, the first switch S1 and the fourth switch S4 may be connected in common to a first node LX1 positioned at one end of the inductor L. The second switch S2 and the third switch S3 may be connected in common to a second node LX2 positioned at another end of the inductor L.

According to an embodiment, the diode D may be connected between the first node LX1 and the ground GND. A cathode electrode of the diode D may be connected to the first node LX1, and an anode electrode thereof may be connected to the ground terminal. For example, the diode D may operate such that a current by the input voltage may not flow to the ground and flow to the inductor L when the first switch S1 is in an on state. In addition, the diode D may form a closed circuit with the first output voltage terminal, when the first switch S1, the second switch S2, and the fourth switch S4 are in an off state and the third switch S3 is in an on state.

According to an embodiment, the first output voltage terminal may be connected to the inductor L through the third switch S3. For example, the first output voltage terminal may activate the first output voltage by receiving energy stored in the inductor when the third switch S3 is in an on state. The first output voltage may be transferred to a first error amplifier EA11210 through a feedback circuit connected to the first output voltage terminal.

According to an embodiment, the first output capacitor CVOP may be connected between the first output voltage terminal and the ground GND. For example, the first output capacitor CVOP may store energy transferred from the inductor and stably transfer the stored energy to the first output voltage terminal.

According to an embodiment, the second output voltage terminal may be connected to the inductor L through the fourth switch S4. For example, the second output voltage terminal may transfer energy to the inductor and activate the second output voltage when the second switch S2 and the fourth switch S4 are in an on state. The second output voltage may be transferred to a second error amplifier EA21220 through the feedback circuit connected to the second output voltage terminal.

According to an embodiment, the second output capacitor CVON may be connected between the second output voltage terminal and the ground GND. For example, the second output capacitor CVON may store energy transferred from the second output voltage terminal and transfer the stored energy to the inductor stably.

According to an embodiment, the power supply control unit 1200 may include the first error amplifier EA11210 and the second error amplifier EA2 1220, a voltage adder VSUM 1230, a ramp generator 1240, a first pulse modulator PWM1 1250, a second pulse modulator PWM2 1260, and the control unit 1270.

According to an embodiment, the first error amplifier 1210 may compare a first feedback voltage FB1 provided from the first output voltage terminal and a reference voltage VREF and output a first error amplification voltage VP. The first feedback voltage FB1 may be a voltage transferred from the first output voltage terminal through a resistive divider circuit. For example, the first feedback voltage FB1 may be a voltage subject to resistance voltage division and adjusted to be appropriate in an input voltage range of the first error amplifier 1210.

According to an embodiment, the second error amplifier 1220 may compare the second feedback voltage FB2 provided from the second output voltage terminal and the ground voltage and output a second error amplification voltage VN. The second feedback voltage FB2 may be a voltage transferred from the second output voltage terminal through the resistive divider circuit. For example, the second feedback voltage FB2 may be a voltage subject to resistance voltage division and adjusted to be appropriate in an input voltage range of the second error amplifier 1220.

According to an embodiment, the voltage adder 1230 may add up the first error amplification voltage VP and the second error amplification voltage VN, and output a summation voltage VPN.

According to an embodiment, the ramp generator 1240 may generate a ramp signal of which a slope is m and having a regular cycle. The ramp signal may overlap the output voltage of the inductor VL. The output voltage of the inductor VL may be a voltage of the second node LX2 to which the second switch S2 connected to another end of the inductor L and the third switch connected to another end of the inductor L are connected in common.

According to an embodiment, the first pulse modulator 1250 may compare the superposition signal generated by adding the ramp signal and the output voltage of the inductor VL to the summation voltage VPN, and generate a first PWM signal.

According to an embodiment, the second pulse modulator 1260 may compare the superposition signal generated by adding the ramp signal and the output voltage of the inductor VL to the second error amplification voltage VN, and generate a second PWM signal.

According to an embodiment, the control unit 1270 may receive the first PWM signal and the second PWM signal and generate the first to fourth control signals G1, G2, G3 and G4 for controlling the first to fourth switches S1, S2, S3 and S4, respectively.

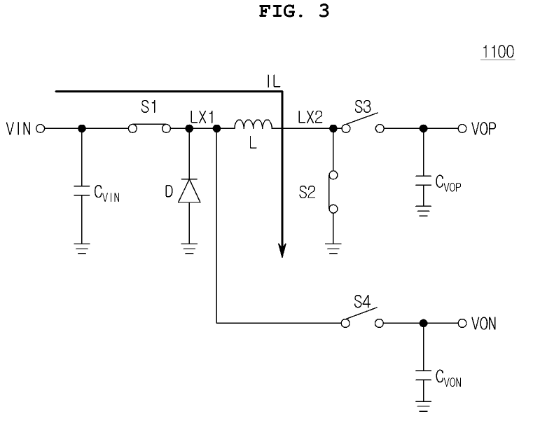

Hereinafter, referring to FIGS. 3 to 6, control of the plurality of switches S1, S2, S3 and S4 by the power supply control unit 1200 will be described in detail.

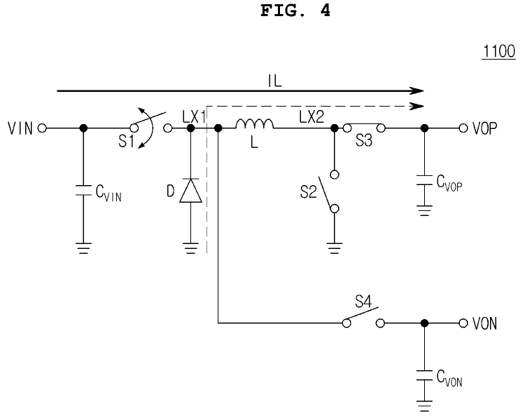

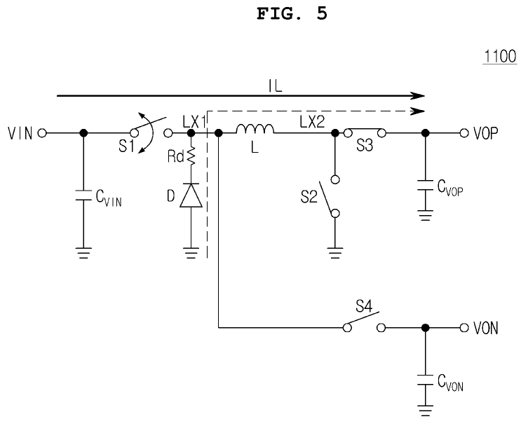

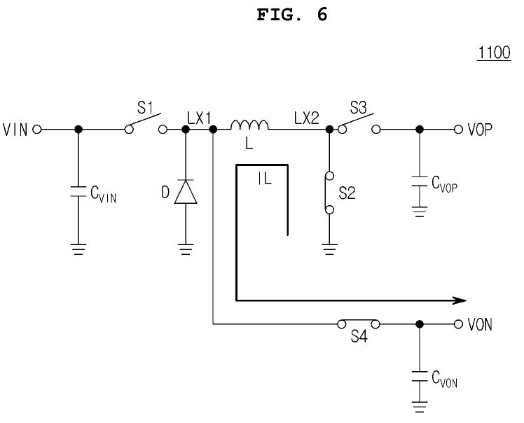

FIG. 3 illustrates an example of controlling the plurality of switches so as to store energy in the inductor of the power supply unit according to an embodiment of the present disclosure. FIG. 4 illustrates an example of controlling the plurality of switches so as to activate the first output voltage according to an embodiment of the present disclosure. FIG. 5 illustrates an example of further including a resistance connected in series to the diode illustrated in FIG. 4. FIG. 6 illustrates an example of controlling the plurality of switches so as to activate the second output voltage according to an embodiment of the present disclosure.

Referring to FIGS. 2 to 6, the power supply control unit 1200 may determine charging and discharging paths of the energy stored in the inductor L by controlling an on state, or an off state of the plurality of switches S1, S2, S3 and S4.

As illustrated in FIG. 3, the power supply control unit 1200 may control the first switch S1 and the second switch S2 to be in an on state, and the third switch S3 and the fourth switch S4 to be in an off state so as to charge energy in the inductor L.

With this configuration, the input voltage VIN may be applied to the inductor L through the first switch S1, and the current which has passed through the inductor L may flow to the ground GND through the second switch S2, thereby the energy is stored in the inductor.

As illustrated in FIG. 4, in order to activate the first output voltage, the power supply control unit 1200 may control the second switch S2 and the fourth switch S4 to be in an off state, maintain the third switch S3 in an on state, and control the first switch S1 to be turned on or off, thereby being able to adjust the first output voltage.

With this configuration, another end of the inductor L may be connected to the first output voltage terminal through the third switch S3, and one end of the inductor L may be connected to or disconnected from the input voltage terminal according to an on state or an off state of the first switch S1. The energy stored in the inductor L may be transferred to the first output voltage terminal, and may stably generate and adjust the first output voltage.

As illustrated in FIG. 5, the power supply unit 1100 may further include a resistance Rd connected between the diode D and the first node LX1. The resistance Rd may serve to ease an inrush current or a surge current by limiting a current flowing through the diode D, and thus, may increase stability of the circuit.

As illustrated in FIG. 6, in order to activate the second output voltage, the power supply control unit 1200 may control the first switch S1 and the third switch S3 to be in an off state, and control the second switch S2 and the fourth switch S4 to be in an on state.

With this configuration, another end of the inductor L may be connected to the ground GND through the second switch S2, and one end of the inductor L may be connected to the second output voltage terminal VON through the fourth switch S4. The current IL may pass through the inductor L from the ground GND and flow in a direction of the second output voltage terminal, and as a result, the second output voltage may have a negative voltage based on the ground.

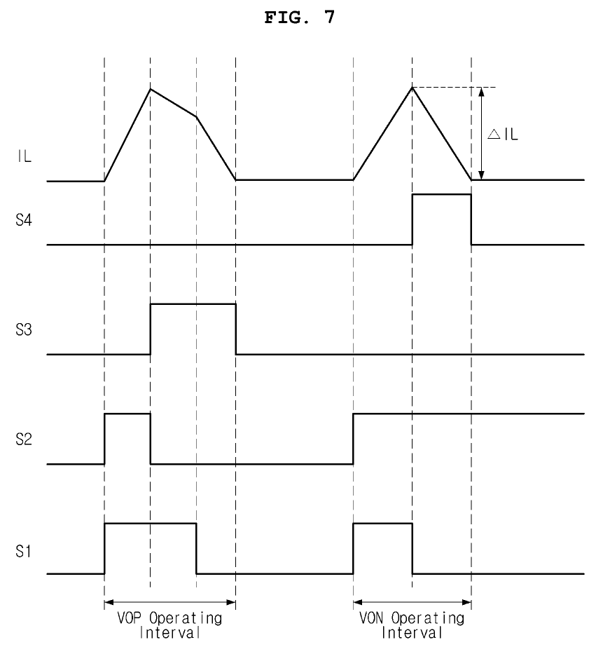

FIG. 7 illustrates an operation of the plurality of switches which activates the first output voltage and the second output voltage according to an embodiment of the present disclosure.

Referring to FIG. 7, at a first output voltage VOP operating interval according to an embodiment of the present disclosure, steps as below may be performed. First, the first switch S1 and the second switch S2 are controlled to be in an on state, the third switch S3 and the fourth switch S4 are controlled to be in an off state, a current IL is applied to the inductor L from the input voltage terminal, and the energy may be charged in the inductor. Next, when the first switch S1 is maintained to be in an on state, the second switch S2 is switched over to an off state, and the third switch S3 is controlled to be in an on state, a current may pass through the inductor L from the input voltage terminal and may be transferred to the first output voltage terminal VOP. Thereafter, when the first switch S1 is switched over to an off state and the third switch S3 is maintained to be in an on state, the current IL may flow in a direction of the first output voltage terminal from the inductor as the energy stored in the inductor is released, and accordingly, the first output voltage VOP may be stably generated and adjusted.

According to an embodiment, at a second output voltage VON operating interval, steps as below may be performed. First, the first switch S1 and the second switch S2 are controlled to be in an on state, the third switch S3 and the fourth switch S4 are controlled to be in an off state, the current IL is applied to the inductor L from the input voltage terminal, and the energy may be charged in the inductor. Next, when the second switch S2 is maintained to be in an on state, the first switch S1 is switched over to an off state, and the fourth switch S4 is controlled to be in an on state, as the energy stored in the inductor is released, the current IL may pass through the inductor L from the ground GND and flow in a direction of the second output voltage terminal. With this configuration, a negative voltage based on the ground may be formed in the second output voltage terminal.

Such first output voltage VOP operating interval and second output voltage VON operating interval are repeated periodically, and the first output voltage VOP having a positive voltage and the second output voltage VON having a negative voltage may be output from the structure of a single inductor L.

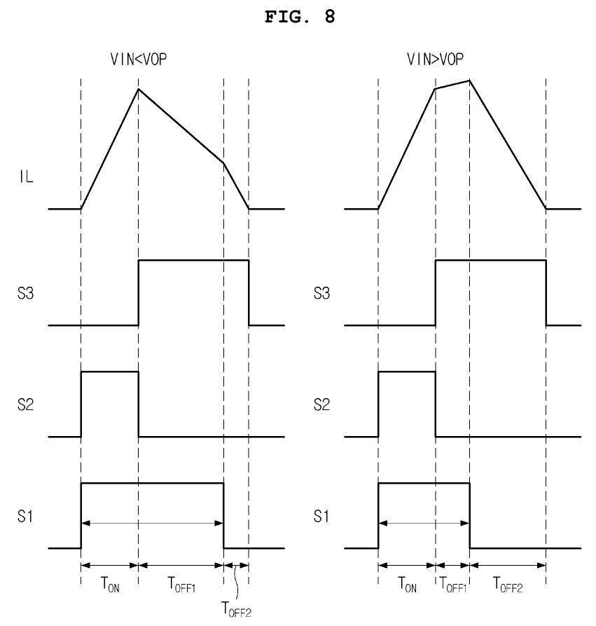

FIG. 8 illustrates an operation of the plurality of switches which adjusts the first output voltage according to an embodiment of the present disclosure.

Referring to FIG. 8, the current IL of the inductor L may be divided by a charging time TON and discharging times TOFF1 and TOFF2. During the charging time TON, the first switch S1 and the second switch S2 may be controlled to be in an on state, the input voltage may be applied to the inductor L, the current IL of the inductor may increase, and the energy may be stored.

Thereafter, the energy stored in the inductor L may be transferred to the first output voltage terminal during the discharging times TOFF1 and TOFF2, and the discharging times TOFF1 and TOFF2 may be divided into a first discharging time TOFF1 and a second discharging time TOFF2.

The first discharging time TOFF1 may be a time at which the energy is directly transferred from the input voltage terminal to the first output voltage terminal, and the second discharging time TOFF2 may be a time at which the energy is transferred from the ground GND to the first output voltage through the diode D. In a condition in which the charging time TON is the same, ratios of the first discharging time TOFF1 and the second discharging time TOFF2 may vary according to relative magnitudes of the input voltage and the first output voltage. For example, when the input voltage is smaller than the first output voltage, the first discharging time TOFF1 becomes longer than the second discharging time TOFF2, and when the input voltage is greater than the first output voltage, the second discharging time TOFF2 becomes longer than the first discharging time TOFF1, thereby the first output voltage may be adjusted.

Therefore, by controlling the charging time TON, the first discharging time TOFF1 and the second discharging time TOFF2, it is possible to form the first output voltage in a desired voltage level.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A power supply apparatus, comprising:
a power supply unit having a single inductor bipolar output (SIBO) converter structure including a single inductor, the power supply unit being configured to receive an input voltage from an input voltage terminal through a plurality of switches connected to the inductor and to generate a first output voltage and a second output voltage, and having one end of the inductor connected to the input voltage terminal and further including a diode connected to the one end of the inductor; and
a power supply control unit configured to control operation of the plurality of switches.

2. The power supply apparatus of claim 1, wherein the plurality of switches comprises:
a first switch connected to the one end of the inductor;
a second switch connected to another end of the inductor;
a third switch connected between the another end of the inductor and a first output voltage terminal; and
a fourth switch connected between the one end of the inductor and a second output voltage terminal.

3. The power supply apparatus of claim 2, wherein a source terminal of the first switch is connected to the input voltage terminal and a drain terminal of the first switch is connected to the diode and the one end of the inductor.

4. The power supply apparatus of claim 2, wherein a drain terminal of the second switch is connected to the another end of the inductor and a source terminal of the second switch is connected to a ground terminal.

5. The power supply apparatus of claim 2, wherein a drain terminal of the third switch is connected to the another end of the inductor and a source terminal of the third switch is connected to the first output voltage terminal, and
wherein a drain terminal of the fourth switch is connected to the one end of the inductor and a source terminal of the fourth switch is connected to the second output voltage terminal.

6. The power supply apparatus of claim 2, wherein a cathode electrode of the diode is connected to a first node to which the first switch, the fourth switch and the one end of the inductor are connected in common, and an anode electrode of the diode is connected to a ground terminal.

7. The power supply apparatus of claim 6, wherein the power supply unit further comprises a resistor connected between the diode and the first node.

8. The power supply apparatus of claim 2, wherein the power supply unit further comprises an input capacitor having a first electrode connected between a source terminal of the first switch and ground.

9. The power supply apparatus of claim 2, wherein the power supply unit comprises:
a first output capacitor connected between the first output voltage terminal and the third switch; and
a second output capacitor comprising a first electrode connected between the second output voltage terminal and the fourth switch.

10. The power supply apparatus of claim 2, wherein the power supply unit comprises:
a first error amplifier configured to compare a first feedback voltage provided from the first output voltage terminal and a reference voltage and output a first error amplification voltage;
a second error amplifier configured to compare a second feedback voltage provided from the second output voltage terminal and a ground voltage and output a second error amplification voltage;
a voltage adder configured to add up the first error amplification voltage and the second error amplification voltage and output a summation voltage;
a ramp generator configured to generate a ramp signal;
a first pulse modulator configured to compare a superposition signal obtained by adding up an output voltage of the inductor and the ramp signal to the summation voltage and generate a first PWM signal;
a second pulse modulator configured to compare the second error amplification voltage and the superposition signal and generate a second PWM signal; and
a control unit configured to control the plurality of switches based on the first PWM signal and the second PWM signal.

11. The power supply apparatus of claim 10, wherein the first feedback voltage is a voltage transferred from the first output voltage terminal through a resistive divider circuit, and
wherein the second feedback voltage is a voltage transferred from the second output voltage terminal through a resistive divider circuit.

12. The power supply apparatus of claim 10, wherein an output voltage of the inductor is a voltage of a second node to which the another end of the inductor, the second switch and the third switch are connected in common.

13. The power supply apparatus of claim 10, wherein the control unit receives the first PWM signal and the second PWM signal and outputs first to fourth control signals for controlling the first to fourth switches, respectively.

14. A method for controlling a single inductor bipolar output (SIBO) converter comprising a single inductor, the method comprising:
providing the SIBO converter that further comprises:
a first switch connected to one end of the inductor;
a second switch connected between another end of the inductor and a ground;
a third switch connected between another end of the inductor and a first output voltage terminal; and
a fourth switch connected between the one end of the inductor and a second output voltage terminal;
charging energy in the inductor by controlling the first switch and the second switch to be in an on state and controlling the third switch and the fourth switch to be in an off state; and
outputting the first output voltage by controlling the second switch and the fourth switch to be in an off state, maintaining the third switch in an on state, and controlling the first switch to be turned on or off.

15. The method of claim 14, wherein the charging of the energy in the inductor further comprises:
outputting a second output voltage by controlling the first switch and the third switch to be in an off state and controlling the second switch and the fourth switch to be in an on state.

16. The method of claim 14, further comprising:
generating a first feedback voltage from the first output voltage terminal through a resistive divider circuit; and
generating a second feedback voltage from the second output voltage terminal through a resistive divider circuit.

17. The method of claim 16, further comprising:
outputting a first error amplification voltage by comparing the first feedback voltage and a reference voltage;
outputting a second error amplification voltage by comparing the second feedback voltage and a ground voltage; and
outputting a summation voltage by adding up the first error amplification voltage and the second error amplification voltage.

18. The method of claim 17, further comprising:
generating a ramp signal having a periodical waveform; and
generating a superposition signal by adding up an output voltage of the inductor and the ramp signal.

19. The method of claim 18, further comprising:
generating a first PWM signal by comparing the summation voltage and the superposition signal; and
generating a second PWM signal by comparing the second error amplification voltage and the superposition signal.

20. The method of claim 19, further comprising:
receiving the first PWM signal and the second PWM signal; and
outputting first to fourth control signals for controlling the first to fourth switches according to the first PWM signal and the second PWM signal.
